(19) United States
(12) Patent Application Publication
(10) Pub. No.: US 2024/0369728 A1
(43) Pub. Date: Nov. 7, 2024

(54) MULTISOURCE SPECTRAL NOISE LOGGING METHOD AND APPARATUS

(71) Applicant: Halliburton Energy Services, Inc., Houston, TX (US)

(72) Inventors: Eduardo ALVES DA SILVA, Rio de Janeiro (BR); Yadong WANG, Singapore (SG); Rafael March CASTANEDA NETO, Rio de Janeiro (BR)

(73) Assignee: Halliburton Energy Services, Inc., Houston, TX (US)

(21) Appl. No.: 18/143,020

(22) Filed: May 3, 2023

(51) Int. Cl. G01V 1/50; E21B 47/107; G01M 3/24

(52) U.S. Cl. CPC G01V 1/50; E21B 47/107; G01M 3/243; G01V 2210/324

(57) ABSTRACT

The present disclosure provides techniques to identify and remove noise that is not relevant to a particular evaluation, and/or to identify and evaluate characteristics of multiple acoustic sources. This is true when evaluations are made that assess the quality of a wellbore, whether that wellbore is currently in a production phase or not. For example, noises associated with removing hydrocarbons from a wellbore, sequestering carbon dioxide in a wellbore, or with hydraulic fracturing may be indicative of normal wellbore operation. Other noises, however, may be indicative of wellbore defects. While methods of the present disclosure may be implemented in wellbores, methods of the present disclosure are not limited to wellbore environments. Methods of the present disclosure may be used to remove noises made by certain types of sound sources such that noises made by other types of sound sources may be evaluated when actions associated with those noises are identified.

### TECHNICAL FIELD

The present disclosure is directed to making evaluations using acoustic information that is relevant to particular tasks. More specifically, the present disclosure is directed to identifying and removing insignificant noise from sensed data such that evaluations can be made regarding noises that may be significant.

### BACKGROUND

Acoustic or sonic logging tools are often employed in wellbore environments for a variety of purposes. In some instances, acoustic sensors may be deployed in a wellbore when evaluations are made relating to whether a wellbore is operation is proceeding properly. Noises associated with leaking fluids in a wellbore environment may be indicative of a defect in the wellbore that could render the wellbore unsuitable for a given task. Other noises (i.e., background noises) detected by the acoustic logging tools may interfere with a computer's ability to analyze the noises associated with the leaking fluids. Because of this, the presence of background noise can prevent a computer from detecting and acting upon noises that may be indicative of a wellbore defect.

Acoustic measurement tools may also be used to collect data for other purposes. For example, a computer could collect vocal data from a person when that person provides commands to the computer. Here again, background noise may obscure acoustic noise that the computer is evaluating. Vocal data provided by the person may be obscured by background noise that makes the computer not able to interpret commands spoken by the person.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A is a schematic diagram of an example logging-while-drilling (LWD) environment, in accordance with various aspects of the subject technology.

FIG. 1B is a schematic diagram of an example wireline logging environment, in accordance with various aspects of the subject technology.

FIG. 2 illustrates assembles that may be used in a wellbore and illustrates sensing equipment that may be used to collect acoustic data from inside the wellbore, in accordance with various aspects of the subject technology.

FIG. 3 illustrates three different sound sources that emit noises that may be detected by two different acoustic sensors, in accordance with various aspects of the subject technology.

FIG. 4 illustrates actions that may be performed when a set of sensor data is received and processed, in accordance with various aspects of the subject technology.

FIG. 5 illustrates actions that may be performed when either a filtering function or analysis is performed based on spectral content associated with particular noise sources, in accordance with various aspects of the subject technology.

FIG. 6 illustrates a series of actions where noises emanating from certain locations are identified and removed from sets of sensed data, in accordance with various aspects of the subject technology.

FIG. 7 illustrates an example architecture of a computing device which can implement the various technologies and techniques described herein.

### DETAILED DESCRIPTION

As discussed in greater detail herein, the present disclosure provides systems, methods, and computer-readable media for identifying and removing noise that is not relevant to a particular evaluation. In particular, the technology can be applied when evaluations are made to the quality of a wellbore, whether that wellbore is currently in a production phase or not. For example, noises associated with removing hydrocarbons from a wellbore, sequestering carbon dioxide in a wellbore, or with hydraulic fracturing may be indicative of normal wellbore operation. Other noises, however, may be indicative of defects in the wellbore. While the technology described in the present disclosure may be implemented in a wellbore, the technology is not limited to wellbore environments. Technology of the present disclosure may be used to remove noises made by certain types of sound sources such that noises made by other types of sound sources may be evaluated when actions associated with those noises are identified.

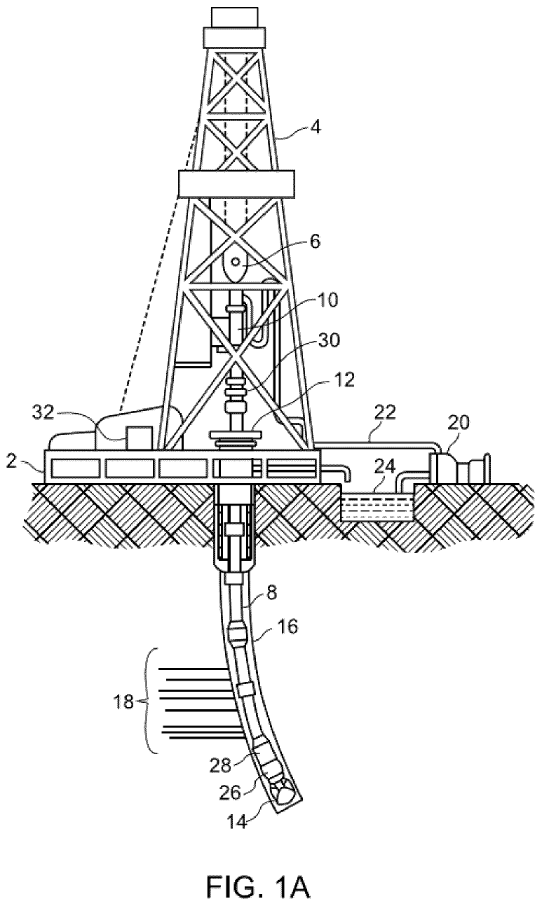

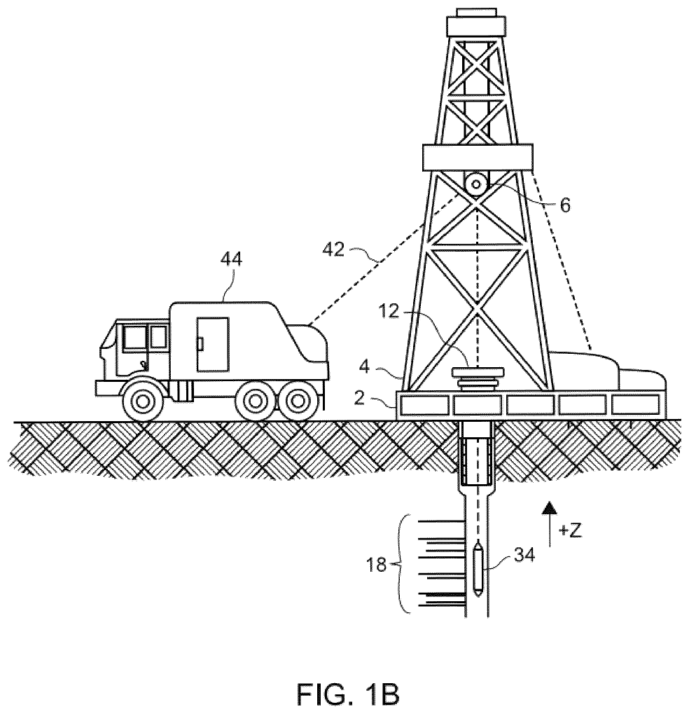

The disclosure now turns to FIGS. 1A-B that provide a brief introductory description of some systems that can be employed to practice the concepts, methods, and techniques disclosed herein. A more detailed description of the methods and systems for implementing the improved semblance processing techniques of the disclosed technology will then follow.

FIG. 1A shows an illustrative logging while drilling (LWD) environment. A drilling platform 2 supports derrick 4 having traveling block 6 for raising and lowering drill string 8. Kelly 10 supports drill string 8 as it is lowered through rotary table 12. Drill bit 14 is driven by a downhole motor and/or rotation of drill string 8. As bit 14 rotates, it creates a borehole 16 that passes through various formations 18. Pump 20 circulates drilling fluid through a feed pipe 22 to kelly 10, downhole through the interior of drill string 8, through orifices in drill bit 14, back to the surface via the annulus around drill string 8, and into retention pit 24. The drilling fluid transports cuttings from the borehole into pit 24 and aids in maintaining borehole integrity.

Downhole tool 26 can take the form of a drill collar (i.e., a thick-walled tubular that provides weight and rigidity to aid the drilling process) or other arrangements known in the art. Further, downhole tool 26 can include acoustic (e.g., sonic, ultrasonic, etc.) logging tools and/or corresponding components, integrated into the bottom-hole assembly near bit 14. In this fashion, as bit 14 extends the borehole through formations, the bottom-hole assembly (e.g., the acoustic logging tool) can collect acoustic logging data. For example, acoustic logging tools can include transmitters (e.g., monopole, dipole, quadrupole, etc.) to generate and transmit acoustic signals/waves into the borehole environment. These acoustic signals subsequently propagate in and along the borehole and surrounding formation and create acoustic signal responses or waveforms, which are received/recorded by evenly spaced receivers. These receivers may be arranged in an array and may be evenly spaced apart to facilitate capturing and processing acoustic response signals at specific intervals. The acoustic response signals are further analyzed to determine borehole and adjacent formation properties and/or characteristics.

For purposes of communication, a downhole telemetry sub 28 can be included in the bottom-hole assembly to transfer measurement data to surface receiver 30 and to receive commands from the surface. Mud pulse telemetry is one common telemetry technique for transferring tool measurements to surface receivers and receiving commands from the surface, but other telemetry techniques can also be used. In some embodiments, telemetry sub 28 can store logging data for later retrieval at the surface when the logging assembly is recovered.

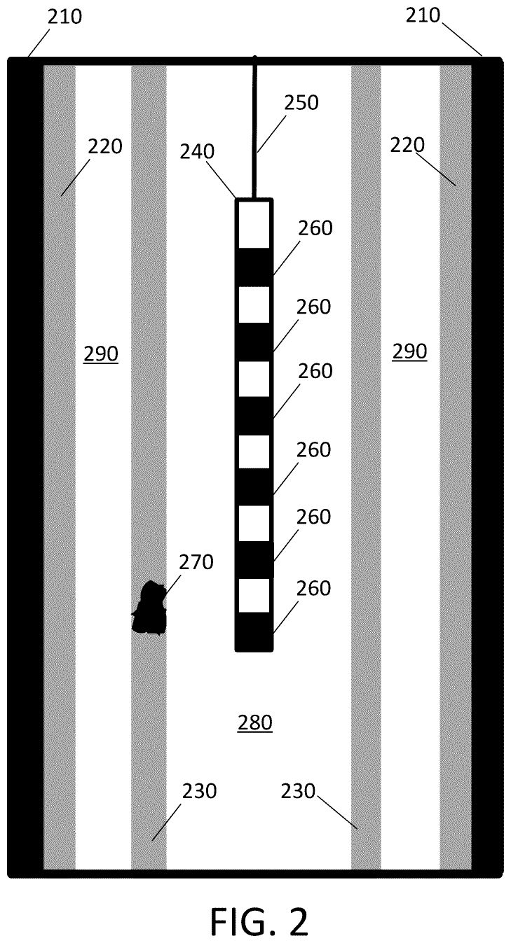

At the surface, surface receiver 30 can receive the uplink signal from the downhole telemetry sub 28 and can communicate the signal to data acquisition module 32. Module 32 can include one or more processors, storage mediums, input devices, output devices, software, and the like as described in detail in FIGS. 2A and 2B. Module 32 can collect, store, and/or process the data received from tool 26 as described herein.

FIG. 1B illustrates how a tool used to collect data may be lowered down a wellbore. FIG. 1B includes many of the same elements discussed in respect to FIG. 1B. For example, FIG. 1B includes platform 2, derrick, 4, block 6, and rotary table 12 that are included in FIG. 1A. At various times during the drilling process, drill string 8 shown in FIG. 1A may be removed from the borehole and downhole tool 34 may then be lowered into the wellbore 16 of FIG. 1A. Once drill string 8 has been removed, logging operations can be conducted using a downhole tool 34 (i.e., a sensing instrument sonde) suspended by a conveyance 42. In one or more embodiments, the conveyance 42 can be a cable having conductors for transporting power to the tool and telemetry from the tool to the surface. Downhole tool 34 may have pads and/or centralizing springs to maintain the tool near the central axis of the borehole or to bias the tool towards the borehole wall as the tool is moved downhole or uphole.

Downhole tool 34 can include an acoustic or sonic logging instrument that collects acoustic logging data within the borehole 16. A logging facility 44 includes a computer system, that may be used to collect, store, and/or process measurements gathered by logging tool 34. In one or more instances, conveyance 42 may include at least one of wires, conductive or non-conductive cable (e.g., slickline, etc.) coupled to downhole tool 34. Conveyance 42 may include tubular conveyances, such as coiled tubing, pipe string, or a downhole tractor. The downhole tool 34 may have a local power supply, such as batteries, a downhole generator, or the like. When employing non-conductive cable, coiled tubing, pipe string, or downhole tractor, communication can be supported using, for example, wireless protocols (e.g. EM, acoustic, etc.), and/or measurements and logging data may be stored in local memory for subsequent retrieval.

Downhole tool 34 may include one or more of a hydrophone, a microphone, an array of hydrophones, or an array of microphones. Such arrays may include one or more hydrophones and/or hydrophones that collect data from a wellbore at various stages of the wellbores life span, from initial phases where wellbores are drilled and made, to when the wellbore is used during a production process (e.g., hydrocarbon extraction or carbon sequestration process), and/or to after a wellbore is put out of service.

Although FIGS. 1A and 1B depict specific borehole configurations, it is understood that the present disclosure is equally well suited for use in wellbores having other orientations including vertical wellbores, horizontal wellbores, slanted wellbores, multilateral wellbores and the like. While FIGS. 1A and 1B depict an onshore operation, it should also be understood that the present disclosure is equally well suited for use in offshore operations. Moreover, the present disclosure is not limited to the environments depicted in FIGS. 1A and 1B, and can also be used, for example, in other well operations such as production tubing operations, jointed tubing operations, coiled tubing operations, combinations thereof, and the like.

The scope of the present disclosure is not limited to the environment shown in FIG. 1A and 1B as methods of the present disclosure may be applied in other environments. Methods and apparatus of the present disclosure may process acoustic data that was received from one or more microphones, hydrophones, piezoelectric sensors, or other equipment that may be capable of sensing acoustic signals, such as sub-sonic, sonic, or ultrasonic signals. This processing may include performing evaluations that allow portions of received acoustic data to be identified based on characteristics known to be representative of specific types of sound sources. Characteristics that may be associated with a sound source include yet are not limited to one or more frequencies emitted by the sound source and/or information that can be used to identify a location of the sound source. Additionally, or alternatively, acoustic noise characteristic of a sound source may be associated with a sound amplitude, a power, or a power spectral density of the noise emitted by the sound source.

Techniques used to evaluate noises in an environment may include a technique referred to as beamforming where signals from different receiving elements of a sensing array (e.g., an array of different hydrophones) may be delayed by different times. This may result in signals being combined constructively to generate a resultant signal that is of greater magnitude than any signal received by a particular sensing element. This may include multiplying signals received from different sensing elements with different gains or weighting factors. In certain instances, the addition of these signals may be performed in the frequency domain. Alternatively or additionally, techniques of the present disclosure may perform a form of signal analysis referred to as independent component analysis (ICA), where matrix math operations are performed to associate particular sounds with specific sound sources.

Other types of separation techniques may be used to evaluate signals from different types of sources include extracting sound from a single object in an environment that includes multiple objects emitting sounds that are superimposed over each other. This may include separating sounds that have multivariate data from other sounds using statistical methods or statistical characteristics. For example, samples of a person's voice may be collected and analyzed to identify characteristics of tone, dynamic range, and/or intonation. Once identified, these samples may be compared with sound information received from a sensor array and characteristics that match the characteristics of the person's voice may be interpreted as coming from that person. This may include comparing sets of voice data from the person with newly acquired data and performing a statistical analysis. Sounds that match characteristics in the set of voice data to at least a threshold level by the statistical analysis may be attributed as being spoken by the person. Sounds that do not match the characteristics in the set of voice data may be filtered out.

Specific types of sound sources may produce sounds that can be collected and analyzed to identify a type of sound source from which a particular sound was emitted. For example, a crack, hole, or other orifice in tubing of wellbore that is producing oil may emit an acoustic noise that could be classified as a whistle sound that has spectral characteristics that include a base frequency, one or more harmonic frequencies, and potentially other frequencies. In such an instance, the base frequency may be a frequency of 110 Hertz (Hz) and the one or more harmonic frequencies may be integer multiples of the base 110 Hz frequency (e.g., 220 Hz or 330 Hz). Other frequencies emitted by this wellbore crack or orifice may be a function of factors such a thickness of the tubing, a space between the tubing and other parts of the wellbore, a hydrocarbon flow rate, densities of hydrocarbons or other substances moving through the wellbore, or other factors. These other factors may also be a combination of a base frequency that is offset based on factors such as the tubing thickness, the space between the tubing and other parts of the wellbore, the hydrocarbon flow rate, material density, or other factors.

In an instance, when a sensor or sensor array senses sounds from two different sound sources, for example, a first sound source that has characteristics consistent with a whistle and second sound source that has characteristics consistent with a vibrating string, the two different sounds may be distinguished from each other even though they may have frequency components that overlap. For example, this can include a comparison of the sound of a flute to the sound of a violin. Here the flute sound would have frequency components that correspond to a volume circumscribed by the flute, keys of the flute that are depressed, and materials from which the flute is made. This may be the case when all of these factors affect the current resonance frequency of the flute. Similarly, the violin sound is a function of string length, string thickness, string tightness, materials that the violin is made of, and other applicable factors. In the context of a wellbore, a flute or whistle sound may be characteristic of a crack in wellbore tubing and the violin or string sound may be characteristic of materials moving between a wellbore casing and wellbore tubing. Other noises may be associated with production materials that move past equipment deployed in the wellbore. For example, a string or cable used to deploy wellbore equipment may make noise.

FIG. 2 illustrates a schematic diagram of assemblies that may be used in a wellbore for collecting acoustic data from inside the wellbore. FIG. 2 includes casing 220 that may be cemented in place into wellbore 210. Wellbore 210 may have been drilled using the equipment illustrated in FIG. 1A and casing 220 may have been fabricated by screwing tubular sections of pipe together after which cement may have been applied between an outer surface of casing 220 and an inner surface of wellbore 210. Tubing 230 may have been inserted into casing 220 after completion of a wellbore cementing process. Because of this, casing 220 may be used to maintain or form a physical isolation barrier between portions of wellbore 220 and an internal portion 290 of casing 220.

After tubing 230 has been inserted into casing 220 of wellbore 210, sensing array 240 may be lowered into casing 220. Sensing assembly 240 may be used to collect acoustic data throughout the lifespan of wellbore 210—when a wellbore is made, during a wellbore production phase, and/or after the wellbore has been placed out of service.

After wellbore 210 is placed into operation, substances may flow through tubing 280 during a production process. Such a production process may relate to hydrocarbon extraction, hydraulic fracturing, or carbon dioxide sequestration. Sensing assembly 240 may be lowered into tubing 230 using string 250. Sensing assembly 240 includes multiple acoustic sensing elements 260 disposed along a length of sensing assembly 240. Each of sensing elements 260 may include one or more acoustic sensors that may be capable of sensing acoustic noise in one or more directions, for example, using directional sensors, omni-directional sensors, multidirectional sensors, or combination of different types of sensors. Hydrophones, microphones, and piezoelectric sensors are examples of sensor types that may be used when methods of the present disclosure are implemented.

The tubing 230 shown in FIG. 2 includes an opening in tubing 230 that may be referred to as an orifice. Orifice 270 may be any defect, for example, a crack, hole, orifice, or other defect. Techniques of the present disclosure may be used to identify tubing defects, tubing leaks, tubing related flows, defects in cement, damaged cement related flows, casing leaks, or other leaks associated with a particular wellbore. These techniques may also identify sounds from another wellbore or a formation near a current wellbore, this may include sounds of a flow of another wellbore, a leak in another wellbore, a flow in a fracture of a formation, or a flow in a permeable matrix of a formation. Materials moving along an inside area 280 of tubing 230 may generate noise as those materials move through, past, or around orifice 270. When a production flow includes providing materials via tubing 230 to some portion of wellbore 210 (not illustrated in FIG. 2), those materials may flow down tubing 230 and through and past orifice 270. When a production flow injected into the portion of the wellbore is carbon dioxide or a fracturing fluid, portions of that fluid may flow through or past orifice 270. The sounds generated by that fluid motion may vary based on a size of orifice 270, a density of the fluid, a pressure of the fluid, a fluid flow rate, or other factors. In certain instances, orifices of different sizes may have similar yet not necessarily identical characteristics. For example, an orifice of a first size may generate noise that includes a base frequency and harmonics of that base frequency. This noise may also include sounds generated as a function of the thickness or type of material (e.g., a type of tubing 230). These noises may also include sounds associated with the motion of the fluid between tubing 230 and casing 220 in area 290 of FIG. 2. Similar factors may be associated with noises generated when fluids (e.g., oil, gas, or water) are extracted from a formation that wellbore 210 is drilled into.

An orifice of a first size may generate noise at frequencies that are a function of the size of the orifice and an intensity of that noise may vary based on operating conditions (e.g., pressure or flow rate) and proximity. An orifice of a larger size may generate noise at different frequencies than the noises generated by a orifice of the smaller size for a given set of conditions. In such instances, other characteristics associated with fluids moving through orifices of different sizes may correspond to each other. For example, frequencies associated with a orifice of the first size may include a base (resonant) frequency of 110 Hz and harmonics of 220 Hz and 330 Hz. An orifice of a second size may include a base frequency of 200 Hz and harmonics of 400 Hz and 600 Hz.

In another example, analysis may include identifying the shape of a spectrum of frequencies from a type of sound source. A type of sound source may generate noises that have a specific spectral signature. A spectrum associated with a casing leak may have high amplitudes of low frequency signals and low amplitudes of higher frequency signals that results in a characteristic curve that fits a pattern. One such pattern could be plotted in a frequency domain map that shows frequencies of sounds and respective amplitudes. A first curve attributed to a particular type of sound source may include sounds at 10 Hz, 25 Hz, and 50 Hz that reduce according to a parabolic function and a second curve attributed to that same particular type of sound source may include sounds at 20 Hz, 50 Hz, and 100 Hz that fit the same parabolic function with different coefficients. Mappings used to identify a type of sound source may use different mathematical functions that are associated with different portions of the frequency spectrum. For example, a type of sound source may have a first portion where spectral magnitudes correspond to an open downward shaped parabola and may have a second portion that corresponds to an open upward shaped parabola. Data collected from two different sound sources that generate noise at different frequencies may both be identified as being emitted from a same type of sound source when mappings of their respective spectral content and magnitude correspond to a same set of functions that have different coefficient values.

Noises associated with orifice 270 may include primary sounds and secondary sounds. Primary sounds may be a function of an orifice size and secondary sounds may be a function of other factors, for example, types of materials or material thickness associated with the noise source. These various factors may result in noises being generated that have a same pattern of respective frequencies as included in the example above where noises generated by the orifice of the smaller size and the larger size correspond to each other based on a base resonant frequency one or more harmonics of the base resonant frequency. Relative amplitudes of these different frequencies may also be associated with a pattern that is characteristic of a orifice 270 in tubing 230. Such relative amplitudes associated with each respective orifice size may correspond to each other based on linear or logarithmic functions. This may be similar to the way the pitch of a piano changes with each respective key as other sound characteristics of a piano may not change even though the pitch of the sound changes.

In certain instances, multiple conditions must be met to identify a type of sound source creating a particular sound. A set of harmonic matching criteria may be necessary yet not sufficient to identify that a particular sound was generated by a crack in a wellbore tube. For example, a sound generated by a type of tubing material and/or a tubing thickness may also be required to identify whether the sound source should be classified as a crack in the tubing. Cracks or other orifices in a type of tubing may be associated with sounds generated by deformation or movement in a portion of the tubing. The orifice 270 in tubing 230 may result in the tube 230 vibrating as fluid leaks from area 280 inside of tubing 230 to area 290 located between an outer surface of tubing 230 and an inner surface of casing 220. In such instances, the harmonic criteria may be associated with a first set of matching criteria and the sounds associated with deformation or movement of the tubing may be associated with a second set of matching criteria. A determination that a particular sound was generated by a crack in wellbore tubing may require both sets of criteria to correspond to sounds that are characteristic of a tubing crack.

Similar determinations may be made to distinguish between sounds made by a violin and sounds made by a piano. Sounds made by the violin and the piano may share some criteria (e.g., the presence of a base frequency and specific harmonics) yet have other sounds that can be used to differentiate a piano sound from a violin sound. For example, the violin sound may include noises associated with a size of resonance chamber in the violin or noises associated with a type of wood that the violin is made of. In contrast, the piano may have a resonance chamber that is larger than the violin's resonance chamber and materials used to make the piano may make sounds that are not characteristic of the violin.

Magnitudes of noises detected by sensing array 240 may vary based on operating conditions and a distance that separates orifice 270 from sensing elements 260 of sensing array 240. A set of magnitudes of acoustic power of one or more frequencies included in a set of sensed data that are associated with a particular sound source may be referred to as a power spectral density of the sound source. Characteristics of a type of sound source may include different frequencies of acoustic noise that each have their own magnitude or power relative to each other. Different noise sources may emit frequencies of a same frequency. Because of this, filtering techniques of the present disclosure may filter sets of sensed data in ways that remove only remove portions of acoustic energy of a particular frequency.

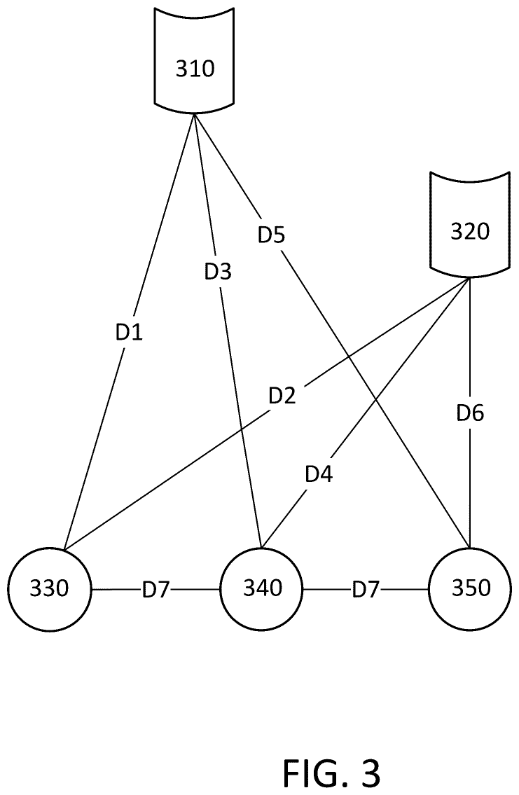

FIG. 3 illustrates two different sound sources that emit noises that may be detected by three different acoustic sensors. FIG. 3 includes sound sources 310 and 320 and acoustic sensors 330, 340, and 350. Acoustic sensor 330 is located at a distance D1 from sound source 310 and is located at a distance D2 from sound source 320. Acoustic sensor 340 is located at a distance D3 from sound source 310 and is located at a distance D4 from sound source 320. Acoustic sensor 350 is located a distance D5 from sound source 310 and is located a distance D6 from sound source 320. Depending on specific types of acoustic sensors used, noises detected by acoustic sensors 330, 340 and 350 may be directional to some degree. In other instances, noises detected by acoustic sensors 330, 340, and 350 may be omni-directional. The medium in which given sets of frequencies move may also affect sounds that reach certain sensors. This is because sounds of some frequencies may be more directional than other frequencies. Furthermore, reflections of sounds off different surfaces may make it difficult to identify a specific location from which a specific sound emanated from. Sounds traveling through water or that echo off surfaces may interfere with the ability of a sensing array to distinguish a location from which those sounds emanate.

Acoustic energy is transmitted through fluids (e.g., air, carbon dioxide, hydrocarbon streams, or water) in a manner that is consistent with the inverse square law and the speed of sound through the fluid. This means that as an acoustic sensor is moved away from a sound source, noise emitted from the sound source will tend to diminish according to the inverse square of the distance between the sound source and the acoustic sensor. Furthermore, noise emitted from a sound source travels at a speed in many directions. This means that noise leaving sound source 310 at a particular moment in time will reach acoustic sensor 330 that is closer to sound source 310 before that noise reaches acoustic sensor 340 that is farther from sound source 310. In other words, noises emitted from sound source 310 will reach acoustic sensor 330 before reaching acoustic sensor 340 because distance D1 is less than distance D3. Furthermore, magnitudes of the noise emitted from sound source 310 that is received by acoustic sensor 330 will be larger than magnitudes of the noise emitted from sound source 310 and that is received by acoustic sensor 340 because the noise magnitude varies based on distance according to the inverse square law. Noises emitted from sound sources 310 and 320 will be received at different times and different amplitudes by respective acoustic sensors 330, 340, and 350 because distances that separate each respective sound source and each respective acoustic sensor is different.

This means that locations of particular sound sources relative to locations where specific acoustic sensors are located may be identified in different ways. A location of a sound source may be identified using several different directional acoustic sensors. When several different directional acoustic sensors receive noise from a same sound source, the location where the sound source is located may be identified using triangulation. By knowing relative locations of each respective acoustic sensor and knowing angles at which each respective acoustic sensor is pointed, vectors along those angles may be projected from each respective acoustic sensor to a point where those vectors intersect. Note that in FIG. 3, acoustic sensor 330 is located at a distance D7 from acoustic sensor 340 and that acoustic sensor 340 is located at distance D7 from acoustic sensor 350. As such, by knowing the distance D7 and by knowing vectors that point along lines D1, D3, and D5, the location of sound source 310 can often be identified. Note also that acoustic sensor 330 is located at a distance of two times distance D7 which equals 2D7.

In an instance when the three acoustic sensors 330, 340, and 350 receive noise from sound sources 310 and 320, the times at which the different sensors receive noise from each respective sound source will be different. Noise emitted by sound source 320 will reach acoustic sensor 350 at a first time T1, reach acoustic sensor 340 at a second time T2, and will then reach acoustic sensor 350 at a third time T3. A beamforming technique may be performed to identify where sound source 320 is located. This may include delaying noise signals received at respective sensors by different amounts of time. When these different amounts of time correspond to respective delay times (i.e., a first set of delay times) of noise from sound source 320 is received by each respective acoustic sensor, a sum of these three different noise signals will reach a peak magnitude. Such a peak magnitude may be referred to as a high energy peak of delayed noise. This first set of delay times will include a first difference in time ΔT1 that equals time T3 minus time T1 and a second difference in time ΔT2 that equals time T3 minus time T2. These time differences and the speed of sound may be used to perform calculations that identify a location of sound source 320. This is because the location of sound source 320 corresponds to distances associated with the respective delay times (time T3 minus time T1; and T3 minus time T2) as well as distances D7 and 2D7 that separate the respective acoustic sensors.

Noises from sound source 310 when summed using delays from this first set of delay times will not result in a peak magnitude because distances that separate sound source 310 from acoustic sensors 330, 340, and 350 are different from distances that separate sound source 320 from acoustic sensors 330, 340 and 350. This is because distances D2, D4, and D6 between sound source 320 and respective acoustic sensors 330, 340, and 350 are different than distances D1, D3, and D5 between sound source 310 and the respective acoustic sensors 330, 340, and 350. As such, a set of delay times that characterize relative timing of noise received from sound source 310 at acoustic sensors 330, 340, and 350 will be different than delay times included in the first set of delay times. A set of evaluations could be performed to identify delay times that result in a peak sum of sounds associated with sound source 310 and based on this, a location of sound source 310 may be identified.

As mentioned above, a form of independent component analysis (ICA) may alternatively or additionally, be performed to associate particular sounds with particular sound sources. For example, sounds from two different sound sources may be combined into a dataset that linearly combines sounds from these two sources into a combined matrix of source sound waveforms X, where X=AS. As such the matrix X may include waveforms of sounds recorded by two different hydrophones as functions of time X1(t) and X2(t), A is a matrix that mixes the components of the sources, and S is a matrix that consists of waveforms of the two sources S1(t) and S2(t). In order to obtain the source matrix S, a mathematical function of S=A⁻¹ or S=WS may be performed. Here A⁻¹ and W represent an inverse matrix of A. An estimate of source matrix S or Ŝ would then consist of two estimated source waveforms Ŝ1(t) and Ŝ2(t). By assuming that the two sources are independent, a matrix W can be found that minimizes the sum of entropies associated with waveforms Ŝ1(t) and Ŝ2(t). Calculations that estimate entropy, for example calculations consistent with Shannon's theorem may then be performed to identify these sums of entropies using the entropy equations below.

$$H 1 ( \hat{S} 1 ) = - {\sum }_{i = 1}^{n} \hat{S} 1 ( {t}_{i} ) {log}_{2} \hat{S} 1 ( {t}_{i} ) \\ H 2 ( \hat{S} 2 ) = - {\sum }_{i = 1}^{n} \hat{S} 2 ( {t}_{i} ) {log}_{2} \hat{S} 2 ( {t}_{i} )$$

### Sum of Entropy Equations

Here the equation H1 is used to calculate entropy to associate with a first sound source and the equation H2 is used to calculate entropy to associate with the second sound source as functions of time Ŝ1(tᵢ) and Ŝ2(tᵢ). These sums may be identified over a number of samples n. Once H1 and H2 are identified, they may be added together to calculate a total entropy E, where E=H1+H2. A plurality of different variations of Ŝ1(t) and Ŝ2(t) may be evaluated when generating different estimates of sums of entropies. A computer modeling inversion process may be performed to find a minimum value of matrix W that corresponds to a minimum value of H1+H2. Examples of inversion methods that may be used to identify matrix W are the Larangian Multiplier Method or Newtonian Iteration. By identifying the sum with a lowest (or minimum) value, sounds to associates with the first sound source and the second sound source may be discriminated from each other to a greater degree of probability as each of these waveforms will correspond to a greater degree of organization or negative entropy because a lowest sum of entropy will correspond to greater organization.

The locations of many different noise sources that surround a sensing array may be identified and maps may be generated that show where each of these different noise sources are located. Such mappings may be referred to as beamforming maps or sound source location maps. In certain instances, such mappings may be incorporated into visualizations that show respective locations of each different respective noise source in two dimensions or in three dimensions. Such mappings may be useful in identify conditions of the wellbore. For example, a first set of noises may be characteristic of fluids moving through an Earth formation and a second set of noises may be characteristic of defects in a set of wellbore tubing, a wellbore casing, or some other wellbore defect.

A second way that could be used to identify a location of a sound source, at least in part, is by comparing magnitudes of noise energy that is received by several different acoustic sensors. For example, in an instance when two different acoustic sensors are located at a same distance from a sound source and a third acoustic sensor is located at some other distance from the sound source, magnitudes of noise received by the first two acoustic sensors may be expected to be the same and a magnitude of noise received by the third acoustic sensor will have some other value. This information should be enough to identify a set of potential locations where the sound source can be located, when plotted on a graph, this set of point would include all points equal distant from each of the first two acoustic sensors while being more distant from the third acoustic sensor. This information is enough to identify locations where the sound source is located based on the inverse square law. While FIG. 3 shows two sound sources, methods the present disclosure may perform similar evaluations on more than two sound sources. While FIG. 3 shows three acoustic sensors, some degree of triangulation could be performed using as few as two acoustic sensors. The more acoustic sensors included in a sensor array may tend to increase the accuracy of determinations made as compared to sensor arrays that used fewer acoustic sensors. In other words, evaluations performed on data collected from N+1 sensors will yield higher resolution location accuracy as compared to evaluations performed on data collected using N sensors.

In instances when an acoustic array includes more than three acoustic sensors, these additional sensors may be located at different distances and relative magnitudes of noise energy received may be used to identify a location of the sound source by solving a set of equations. In such instances, known distances between respective acoustic sensors and measured differences in sensed acoustic energy from each of those respective acoustic sensors may be used to identify the location of the sound source.

A third way that a location of the sound source could be identified is by identifying differences in time when specific noise signals are received at specific acoustic sensors. These differences in time may be used to identify a set of possible locations where the acoustic sensor is located. Here again the more sensors used may help identify the location of the sound source based on the speed that noise travels from the sound source to the respective acoustic sensors.

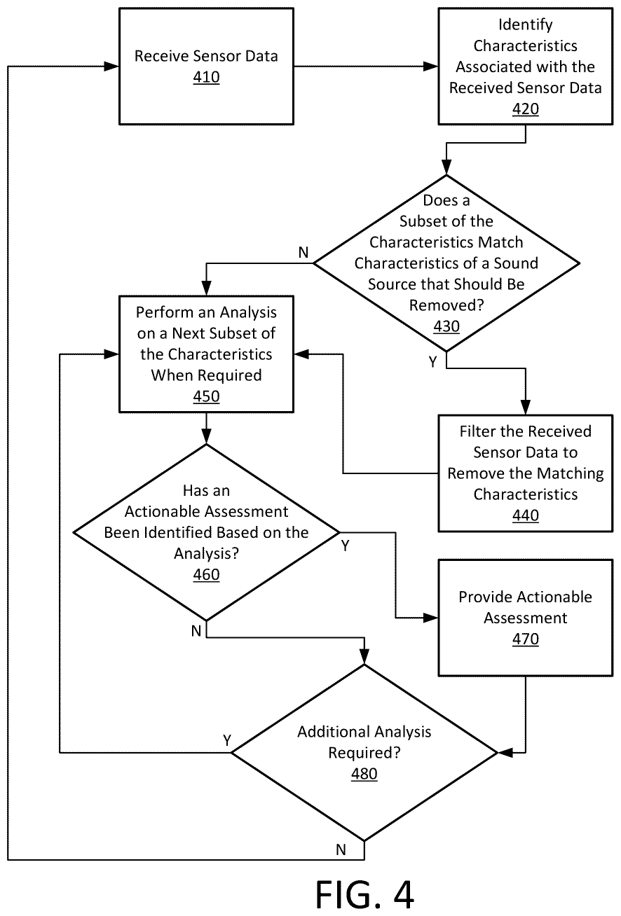

FIG. 4 illustrates actions that may be performed when a set of sensor data is received and processed. At block 410 a set of sensor data may be received from one or more acoustic sensors. Here again this may include receiving data from one or more hydrophones, microphones, piezoelectric sensing elements, or other types of sensors capable of sensing subsonic, sonic, and/or ultrasonic frequencies. At block 420 characteristics associated with the received sensor data may be identified. The characteristics identified at block 420 may include identifying frequencies and possible magnitudes of frequencies of acoustic signals included in the received sensor data. This received sensor data may include noises that were emitted from different noise sources that each have their own set of spectral content. Alternatively, or additionally, locations associated with specific noise sources may be identified at block 420 when possible.

Determination step 430 may then identify whether a subset of the characteristic included in the received sensor data match characteristics of a sound source that should be removed from the set of sensed data (for at least a current set of evaluations), when yes, the set of received sensor data may be filtered to remove the matching characteristics at block 440. This may result in a new set of data being generated. Such a filtering function may include filtering out specific amounts of power of acoustic energies at specific frequencies that are attributed to a first sound source. Alternatively, or additionally, this may include filtering the received sensor data to remove frequency components that are associated with a location associated with the first sound source.

The filtering function performed at block 440 may remove at least portions of the received sensor data. Filtering functions can be performed to filter out data that is associated with any number of noise sources such that analysis of data associated with other sources may be performed. Of course, an original set of sensor data may be stored such that data that was previously filtered out can be analyzed, potentially at a later time.

Either after block 440 filters out unwanted noise or when determination block 430 identifies that the subset of characteristics does not match characteristics of a sound source that should be removed, program flow may move to block 450 of FIG. 4. An analysis may be performed at block 450 on a next subset of the characteristics identified at block 420, when required. The analysis performed at block 450 may identify that a particular sound source corresponds to type of sound source that is of interest or that could negatively affect a process (e.g., a production process of a wellbore or wellbore integrity). After block 450, a determination may be made at block 460 as to whether an actionable assessment has been identified based on the analysis performed at block 450.

When the sound source resides in a wellbore, the analysis performed at block 450 could identify that materials are moving through an orifice in a wellbore tubing. In such an instance, an actional assessment may be to recommend that the orifice should be repaired. While an orifice in a set of wellbore tubing has been discussed, methods of the present disclosure may be used to identify other types of wellbore sounds. As mentioned above, sounds that may be identified may include tubing defects, tubing leaks, tubing related flows, defects in cement, damaged cement related flows, casing leaks, or other leaks associated with a particular wellbore. Furthermore, identified sounds may be from another wellbore or a formation near a current wellbore—a flow of another wellbore, a leak in another wellbore, a flow in a fracture of a formation, or a flow in a permeable matrix of a formation.

A source of interest can include a person that provides an audio command to a computer (e.g., a robot or other system) that receives and processes voice commands. In an instance when the received sensor data includes vocal instructions from a person and other audio data, the filtering function performed at block 440 may remove the other audio data. The analysis performed at block 450 may then identify the command provided by the person. An apparatus that initiates actions based on received commands may then perform a function associated with that command. The function of initiating an action associated with a received command may be classified as an actionable assessment. As such determination block 460 may identify that an appropriate assessment may be acted upon. Program flow may then move to block 470 of FIG. 4 where the actionable assessment is provided or acted upon.

Voices of specific individuals may be identified using techniques consistent with an independent component analysis (ICA) signal processing technique that was discussed in respect to FIG. 3 above. This may include receiving audio signals from a plurality of different sources by a plurality of different acoustic sensors. A first acoustic sensor that is closer to a first person will receive a magnitude of acoustic (e.g., voice) energy from the first person than a second acoustic sensor that is farther from the first person. Likewise, a second acoustic sensor may receive acoustic energy from a second person that is greater than acoustic energy received by the first acoustic sensor. A third acoustic sensor may receive acoustic energy from respective sources based on how far the third acoustic sensor is from the first person, the second person, or other people located near respective acoustic sensors in an array of acoustic sensors. Data sensed by different acoustic sensors may include non-Gaussian distributions and each of the different acoustic sensors may receive acoustic energy from a plurality of sources at different magnitudes. Mathematic operations may be performed on different sets of acoustic data received by different sensors to separate acoustic data from different sources. This may include assuming that the mixed noise includes characteristics of a particular person's voice that can be isolated from the mixed noise based on evaluations associated with these characteristics.

In the instance when the actionable assessment corresponds to a command provided by a person, that command may result in a light being turned on or that command may result in a product being delivered (for example)—in either instance, the actionable assessment performed at block 470 may be associated with or may correspond to the command. In the instance when the actionable assessment is to provide a warning regarding repairing the orifice in the wellbore tubing, casing, or cement, a warning message may be sent to operators of the wellbore and this warning message may result in the orifice being repaired.

Either when determination block 460 does not identify an actionable assessment or after the actional assessment is provided at block 470, program flow may move to determination block 480 that identifies whether additional analysis is required. When yes, program flow may move back to block 450 where an analysis is performed on a next subset of the characteristics identified at block 420. When determination block 480 identifies that additional analysis is not required, program flow may move back to block 410 where additional sensor data may be received.

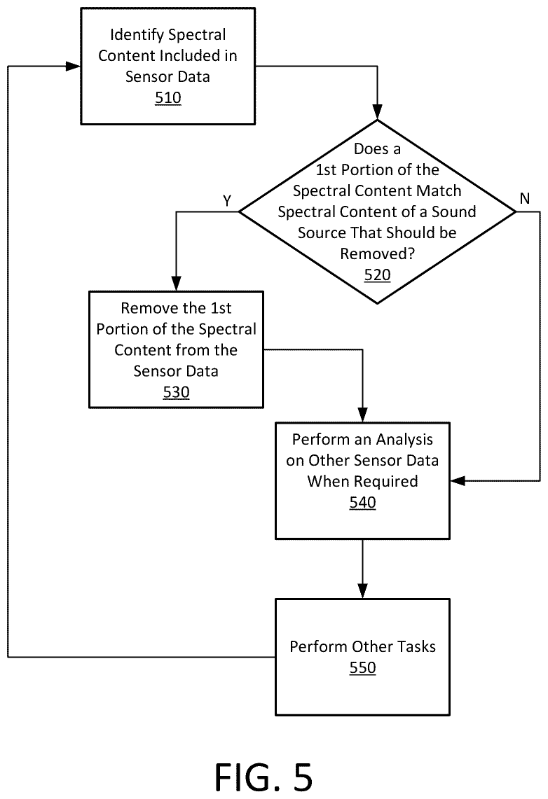

FIG. 5 illustrates actions that may be performed when either a filtering function or analysis is performed based on spectral content associated with particular noise sources. FIG. 5 begins with block 510, where spectral content included in a set of sensor data is identified. Actions performed at block 510 may include actions described with respect to block 420 of FIG. 4. Frequencies and power levels associated with received acoustic energy may be identified at block 510. As mentioned above, such a dataset may include noises from different noise sources. Some of these noise sources may be inconsequential and data attributed to those inconsequential noise sources may be filtered out. Other noise sources may be from a noise source of interest (e.g., a person's voice or a noise associated with a potential wellbore defect).

Determination block 520 may then identify whether a first portion of the spectral content of an identified sound source should be removed from a set of sensed data. Noise sources that are considered inconsequential may be removed from (filtered out of) the set of sensed data at block 530. Program flow may move to block 540 of FIG. 5 either after block 530 or when determination block 520 identifies that the sensor data does not include acoustic data that should be removed from the sensor data.

As mentioned above, two different sound sources may emit noises that include a same frequency or frequencies. Information included in Table 1 below shows magnitudes of acoustic noise that are received from two different noise sources by a set of acoustic sensors. Table 1 shows that data from a first source includes noises at 110 Hz, 200 Hz, 220 Hz, and 330 Hz. Respective magnitudes of noise from this first source at each of these frequencies are 100 Db, 80 Db, 50 Db, and 25 Db. Such a distribution may be consistent with a first type of sound source that emits acoustic energy at each of these frequencies (110 Hz, 200 Hz, 220 Hz, and 330 Hz) with power level ratios of 1.0, 0.8, 0.5, and 0.25 respectively. From this information, the first type of sound source may be judged to be a crack in a wellbore tube. As such the power spectral density of the cracked wellbore tube corresponds to the measured respective frequency and power levels of 100 Db at 110 Hz, 80 Db at 200 Hz, 50 Db at 220 Hz, and 25 Db at 300 Hz. In this example, the 220 Hz and 330 Hz frequencies may be harmonics of the 110 Hz base frequency, where power levels of each respective harmonic reduce geometrically as comparted to the power level associated with the base frequency.

Table 1 also shows that noise emitted from a second sound source includes noises at 50 Hz, 100 Hz, 150 Hz, 200 Hz, and 250 Hz with respective power levels of 200 Db, 100 Db, 50 Db, 25 Db, and 12.5 Db. In this instance, noises at 100 Hz, 150 Hz, 200 Hz, and 250 Hz may be harmonics of the base frequency of 50 Hz, where power levels of each respective harmonic reduce geometrically as compared to the power level associated with the base frequency. This second sound source may be judged to be an inconsequential noise source that should be filtered out of a dataset. Since each of the sound sources emit noses with a frequency of 200 Hz, it would not be appropriate to filter out all of the noise that has a frequency of 200 Hz. Instead, determination step 520 may identify that only some portion of the sound energy should be filtered out of the dataset that includes noises from each of the two noise sources. Furthermore, determination step 520 may identify that all noise at frequencies of 100 Hz, 150 Hz, and 250 Hz included in the dataset should be filtered out. Table 1 also shows total values of acoustic power at each of the frequencies discussed above, where the first sound source contributes 80 Db of the 105 Db total power of acoustic energy sensed at 200 Hz. This is because the second sound source provides an acoustic energy value of 25 Db at 200 Hz.

TABLE 1
Sound Power from Different Sources at Different Frequencies

| Frequency Hz | 1st source Db | 2nd source Db | Total Db |
|---|---|---|---|
| 50 | 0 | 200 | 200 |
| 100 | 0 | 100 | 20 |
| 110 | 100 | 0 | 100 |
| 150 | 0 | 50 | 50 |
| 200 | 80 | 25 | 105 |
| 220 | 50 | 0 | 50 |
| 250 | 0 | 12.5 | 12.5 |
| 300 | 0 | 0 | 0 |
| 330 | 25 | 0 | 25 |

One way in which such a filtering function could be performed is by using notch filters that filter out 100 percent of acoustic energy at 100 Hz, 150 Hz, and 250 Hz and by using a notch filter that filters out 23.5 percent of the acoustic energy at 200 Hz.

Since initially, the types of sound sources present may be unknown, yet could include one or more previously characterized sound sources, total spectral content may be evaluated to identify potential types of sound sources present. When received sensor data includes sounds of a set of frequencies that are consistent with a particular type of sound source and when the sensed data indicates that power levels at each of these frequencies are consistent with the power spectral density of a particular type of sound source, that particular type of sound source may be judged as possibly being one of the sound sources from which acoustic energy was received by acoustic sensors. Because of this, evaluations relating to power spectral density alone may be used to identify that the second sound source is associated with either an inconsequential or a consequential sound source.

As mentioned above, associations between different frequencies included in a set of sensed data may be indicative of a type of sound source even though components of sound energy in the set of sensed data do not include a particular set of frequencies. In an instance when a consequential sound source is a violin, each of the notes played by the violin may have spectral characteristics that correspond to each other that can be used to identify that the violin is the sound source. So even though each different note played by a violin may have a different base frequency and different harmonic frequencies, the presence of the frequencies at relative intervals and at relative power levels, potentially combined with other acoustic data (e.g., sounds associated with the structure of a violin and/or materials used to make the violin) may be used to uniquely identify that the sound source is a violin.

Such evaluations could result in portions power of levels at particular frequencies being filtered out of a dataset at block 530. As such, a portion of spectral content included in a set of sensed data may be removed at block 530 of FIG. 5. Either when determination step 520 identifies that the first portion of spectral content should not be removed or after that content is removed at block 530, program flow may move to block 540 where other analysis are performed. This may include identifying spectral content associated with a second type of sound source, for example. After block 540, other tasks may be performed at block 550. These other tasks may include identifying locations of respective sound sources or identifying and providing actional assessments as discussed in respect to block 460 and 470 of FIG. 4.

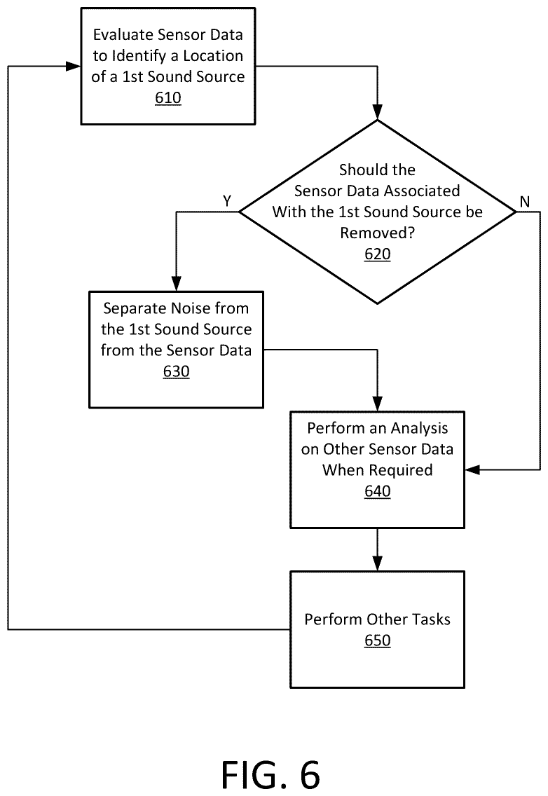

FIG. 6 illustrates a series of actions where noises emanating from certain locations are identified and removed from sets of sensed data. One or more sensors located in a sensing apparatus may only receive noise from certain directions. In such instances, noises may be received via different inputs or input channels and those noises may be stored in separate datasets. Noises from a particular sensor may be removed from sets of sensed data based on noises sensed by that particular sensor not being located at a point of interest. Other noises received by other directional sensors may be evaluated at block 610 such that determinations related to these other noises may be made.

A sensor array may include some sensors that are directional and other sensors that are not directional. Because of this, evaluations of sensed data may include comparing data received from directional sensors with data received from sensors that are not directional. Unwanted noises that were sensed by directional sensors that are also sensed by non-directional sensors, may be identified and removed from respective datasets when evaluations are made.

Determination block 620 may identify whether data associated with a first sound source should be removed from one or more sets of received data. When determination block 620 identifies that the noise from the first sound source should be removed, noise associated with the first sound source may be removed from one or more datasets at block 630. Either when determination block 620 identifies that sensor data associated with the first sound source should not be removed from sensed data or after block 630, other analysis may be performed on received sensor data at block 640. Evaluations performed at block 640 may include evaluations discussed in respect to FIGS. 2-5 of the present disclosure. After block 650 other tasks may be performed and then program flow may move back to block 610 of FIG. 6. The other tasks that may be performed at block 650 may include collecting additional sensor data such that other evaluations may be made.

As discussed above, various techniques that may be used to identify locations where specific sound sources are located relative to a sensor array may include the use of directional sensors and triangulation, by identifying differences in time when particular sounds are received at particular sensors, or by identifying differences in power of those particular sounds that are received by the particular sensors.

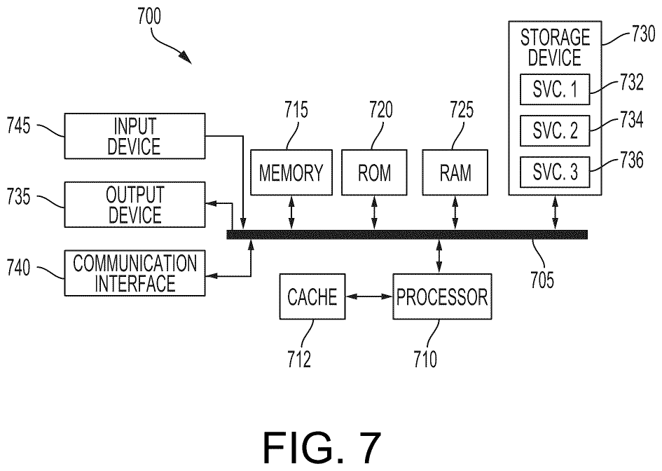

FIG. 7 illustrates an example architecture 700 of a computing device which can implement the various technologies and techniques described herein. The various implementations will be apparent to those of ordinary skill in the art when practicing the present technology. Persons of ordinary skill in the art will also readily appreciate that other system implementations or examples are possible. The components of the computing device architecture 700 are shown in electrical communication with each other using a connection 705, such as a bus. The example computing device architecture 700 includes a processing unit (CPU or processor) 710 and a computing device connection 705 that couples various computing device components including the computing device memory 715, such as read only memory (ROM) 720 and random-access memory (RAM) 725, to the processor 710.

The computing device architecture 700 can include a cache of high-speed memory connected directly with, in close proximity to, or integrated as part of the processor 710. The computing device architecture 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other computing device memory 715 may be available for use as well. The memory 715 can include multiple different types of memory with different performance characteristics. The processor 710 can include any general-purpose processor/multi-processor and a hardware or software service, such as service 1 732, service 2 734, and service 3 736 stored in storage device 730, configured to control the processor 710 as well as a special-purpose processor where software instructions are incorporated into the processor design. The processor 710 may be a self-contained system, containing multiple cores or processors, a bus, memory controller, cache, etc. A multi-core processor may be symmetric or asymmetric.

To enable user interaction with the computing device architecture 700, an input device 745 can represent any number of input mechanisms, such as a microphone for speech, a touch-sensitive screen for gesture input, keyboard, mouse, motion input, speech and so forth. An output device 735 can also be one or more of a number of output mechanisms known to those of skill in the art, such as a display, projector, television, speaker device, etc. In some instances, multimodal computing devices can enable a user to provide multiple types of input to communicate with the computing device architecture 700. The communications interface 740 can generally govern and manage the user input and computing device output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof. The storage device 730 can include services 732, 734, 736 for controlling the processor 710. Other hardware or software modules are contemplated. The storage device 730 can be connected to the computing device connection 705. In one aspect, a hardware module that performs a particular function can include the software component stored in a computer-readable medium in connection with the necessary hardware components, such as the processor 710, connection 705, output device 735, and so forth, to carry out the function.

For clarity of explanation, in some instances the present technology may be presented as including individual functional blocks including functional blocks comprising devices, device components, steps or routines in a method embodied in software, or combinations of hardware and software.

In some instances the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

### Aspects of the Disclosure

Aspect 1 of the present disclosure may include performing an evaluation to identify a plurality of characteristics of a set of sensed acoustic data; comparing the plurality of characteristics of the sensed acoustic data with one or more characteristics of a first type of sound source; identifying, based on the comparison, that a first subset of the plurality of characteristics corresponds to the one or more characteristics of the first type of sound source; and initiating a filtering function to separate the first subset of the plurality of characteristics from the set of acoustic data. This method may also include performing an analysis on a second subset of the plurality of characteristics to identify metrics to associate with the second subset of the plurality of characteristics, wherein the second subset of the plurality of characteristics is associated with one or more characteristics of a second type of sound source and an actionable assessment is initiated based on the metrics identified by the analysis on the second subset of the plurality of characteristics being associated with the one or more characteristics of the second type of sound source.

Aspect 2: The method of Aspect 1, further comprising identifying spectral content of the set of sensed acoustic data; accessing stored data that includes the one or more characteristics of the first type of sound source; and identifying spectral content associated with the first type of sound source after accessing the stored data, wherein the filtering function separates the spectral content associated with the first type of sound source from the spectral content of the set of sensed acoustic data.

Aspect 3: The method of Aspects 1 or 2, wherein the first subset of the plurality of characteristics includes a set of frequencies of the first type of sound source.

Aspect 4: The method of any of Aspects 1 through 3, wherein the first subset of the plurality of characteristics of the type of sound source includes a magnitude of the set of frequencies of the sound source.

Aspect 5: The method of any of Aspects 1 through 4, further comprising identifying an estimated location to associate with the second type of sound source based on an analysis of the one or more characteristics of the second type of sound source.

Aspect 6: The method of any of Aspects 1 through 5, further comprising identifying a first sum of acoustic energy that is associated with a first set of delay times by, delaying a first portion of the acoustic energy by a first delay based on the first portion of the acoustic energy being received by a first acoustic sensor of an acoustic array, wherein the first delay is included in the first set of delay times, delaying a second portion of the acoustic energy by a second delay based on the second portion of the acoustic energy being received by a second acoustic sensor of the acoustic array, wherein the second delay is included in the first set of delay times, and adding the first portion of the acoustic energy to the second portion of the acoustic energy and to a third portion of the acoustic energy. The method may also include comparing the first sum of the acoustic energy, a second sum of the acoustic energy associated with a second set of delay times, and a third sum of acoustic energy that is associated with a third set of delay times; and identifying a location of the first type of sound source based on the first sum of acoustic energy being greater than the second sum of acoustic energy and the third sum of acoustic energy and based on the first set of delay times.

Aspect 7: The method of any of Aspects 1 through 6, further comprising: identifying a first magnitude of a first portion of sound energy received by a first sensor of a sensor array; identifying a second magnitude of a second portion of the sound energy received by a second sensor of the sensor array; identifying a third magnitude of a third portion of the sound energy received from a third sensor of the sensor array; and identifying the estimated location of the type of sound source based on an evaluation that compares the first magnitude of the first portion of sound energy with the second magnitude of the second portion of sound energy and with the third magnitude of the third portion of the sound energy.

Aspect 8: The method of any of Aspects 1 through 7, further comprising classifying the second subset of the plurality of characteristics as belonging to a wellbore defect, wherein the actional assessment includes providing an alert to administrative staff that identifies the wellbore defect.

Aspect 9: The method of any of Aspects 1 through 8, further comprising calculating a first power spectral density associated with a sound emitted by the first type of sound source by identifying power levels associated with a plurality of frequencies included in the sound emitted by the first type of sound source; and calculating a second power spectral density associated with a sound emitted by the second type of sound source by identifying power levels associated with a plurality of frequencies included in the sound emitted by the first type of sound source.

Aspect 10. The method of any of Aspects 1 through 9, further comprising estimating a first value of entropy by calculating a first set of sums that are associated with a first sound source, wherein the first sound source is the first type of sound source; estimating a second value of entropy by calculating a second set of sums that are associated with a second sound source, wherein the second sound source is the second type of sound source; adding the first value of entropy and the second value of entropy to generate a sum of entropies. This method may also include comparing the sum of entropies to a plurality of other entropy sums; and identifying that the sum of entropies has a value that is lower than the other entropy sums.

Aspect 11: The method of Aspect 10, further comprising identifying the first sound source and the second sound source based on the sum of entropies having the value that is lower than the other entropy sums.

Aspect 12: A non-transitory computer-readable storage medium having embodied thereon instructions executable by one or more processors to implement a method comprising: performing an evaluation to identify a plurality of characteristics of a set of sensed acoustic data; comparing the plurality of characteristics of the sensed acoustic data with one or more characteristics of a first type of sound source; identifying, based on the comparison, that a first subset of the plurality of characteristics corresponds to the one or more characteristics of the first type of sound source; and initiating a filtering function to separate the first subset of the plurality of characteristics from the set of acoustic data. The one or more processors may also execute instructions out of the memory to perform an analysis on a second subset of the plurality of characteristics to identify metrics to associate with the second subset of the plurality of characteristics, wherein the second subset of the plurality of characteristics is associated with one or more characteristics of a second type of sound source and an actionable assessment is initiated based on the metrics identified by the analysis on the second subset of the plurality of characteristics being associated with the one or more characteristics of the second type of sound source.

Aspect 13: The non-transitory computer-readable storage medium of Aspect 12, wherein the one or more processors execute the instructions to identify spectral content of the set of sensed acoustic data; access stored data that includes the one or more characteristics of the first type of sound source; and identify spectral content associated with the first type of sound source after accessing the stored data, wherein the filtering function separates the spectral content associated with the first type of sound source from the spectral content of the set of sensed acoustic data.

Aspect 14: The non-transitory computer-readable storage medium of Aspects 12 or 13, wherein the first subset of the plurality of characteristics includes a set of frequencies of the first type of sound source.

Aspect 15: The non-transitory computer-readable storage medium of any of Aspects 12 through 14, wherein the first subset of the plurality of characteristics of the type of sound source includes a magnitude of the set of frequencies of the sound source.

Aspect 16: The non-transitory computer-readable storage medium of any of Aspects 12 through 15, wherein the one or more processors execute the instructions to identify an estimated location to associate with the second type of sound source based on an analysis of the one or more characteristics of the second type of sound source.

Aspect 17: The non-transitory computer-readable storage medium of any of Aspects 12 through 16, wherein the one or more processors execute the instructions to identify a first sum of acoustic energy that is associated with a first set of delay times by delaying a first portion of the acoustic energy by a first delay based on the first portion of the acoustic energy being received by a first acoustic sensor of an acoustic array, wherein the first delay is included in the first set of delay times. delaying a second portion of the acoustic energy by a second delay based on the second portion of the acoustic energy being received by a second acoustic sensor of the acoustic array, wherein the second delay is included in the first set of delay times and adding the first portion of the acoustic energy to the second portion of the acoustic energy and to a third portion of the acoustic energy. The one or more processors may also execute instructions out of the memory to compare the first sum of the acoustic energy, a second sum of the acoustic energy associated with a second set of delay times, and a third sum of acoustic energy that is associated with a third set of delay times; and identify a location of the first type of sound source based on the first sum of acoustic energy being greater than the second sum of acoustic energy and the third sum of acoustic energy and based on the first set of delay times.

Aspect 18: The non-transitory computer-readable storage medium of any of Aspects 12 through 17, wherein the one or more processors execute the instructions to identify a first magnitude of a first portion of sound energy received by a first sensor of a sensor array; identify a second magnitude of a second portion of the sound energy received by a second sensor of the sensor array; identify a third magnitude of a third portion of the sound energy received from a third sensor of the sensor array; and identify the estimated location of the type of sound source based on an evaluation that compares the first magnitude of the first portion of sound energy with the second magnitude of the second portion of sound energy and with the third magnitude of the third portion of the sound energy.

Aspect 19: The non-transitory computer-readable storage medium of any of Aspects 12 through 18, wherein the one or more processors execute the instructions to classify the second subset of the plurality of characteristics as belonging to a wellbore defect, wherein the actional assessment includes providing an alert to administrative staff that identifies the wellbore defect.

Aspect 20: An apparatus comprising: a set of sensors that sense a plurality of characteristics of a set of sensed acoustic data; a memory; and one or more processors that execute instructions out of the memory to: perform an evaluation to identify the plurality of characteristics of the set of sensed acoustic data; compare the plurality of characteristics of the sensed acoustic data with one or more characteristics of a first type of sound source; identify, based on the comparison, that a first subset of the plurality of characteristics corresponds to the one or more characteristics of the first type of sound source; and initiate a filtering function to separate the first subset of the plurality of characteristics from the set of acoustic data. The one or more processor may also execute instructions to perform an analysis on a second subset of the plurality of characteristics to identify metrics to associate with the second subset of the plurality of characteristics, wherein the second subset of the plurality of characteristics is associated with one or more characteristics of a second type of sound source and an actionable assessment is initiated based on the metrics identified by the analysis on the second subset of the plurality of characteristics being associated with the one or more characteristics of the second type of sound source.

What is claimed is:

1. A method comprising:
performing an evaluation to identify a plurality of characteristics of a set of sensed acoustic data;
comparing the plurality of characteristics of the sensed acoustic data with one or more characteristics of a first type of sound source;
identifying, based on the comparison, that a first subset of the plurality of characteristics corresponds to the one or more characteristics of the first type of sound source;
initiating a filtering function to separate the first subset of the plurality of characteristics from the set of acoustic data; and
performing an analysis on a second subset of the plurality of characteristics to identify metrics to associate with the second subset of the plurality of characteristics, wherein the second subset of the plurality of characteristics is associated with one or more characteristics of a second type of sound source and an actionable assessment is initiated based on the metrics identified by the analysis on the second subset of the plurality of characteristics being associated with the one or more characteristics of the second type of sound source.

2. The method of claim 1, further comprising:
identifying spectral content of the set of sensed acoustic data;
accessing stored data that includes the one or more characteristics of the first type of sound source; and
identifying spectral content associated with the first type of sound source after accessing the stored data, wherein the filtering function separates the spectral content associated with the first type of sound source from the spectral content of the set of sensed acoustic data.

3. The method of claim 1, wherein the first subset of the plurality of characteristics includes a set of frequencies of the first type of sound source.

4. The method of claim 3, wherein the first subset of the plurality of characteristics of the type of sound source includes a magnitude of the set of frequencies of the sound source.

5. The method of claim 1, further comprising:
identifying an estimated location to associate with the second type of sound source based on an analysis of the one or more characteristics of the second type of sound source.

6. The method of claim 1, further comprising:
identifying a first sum of acoustic energy that is associated with a first set of delay times by:
delaying a first portion of the acoustic energy by a first delay based on the first portion of the acoustic energy being received by a first acoustic sensor of an acoustic array, wherein the first delay is included in the first set of delay times,
delaying a second portion of the acoustic energy by a second delay based on the second portion of the acoustic energy being received by a second acoustic sensor of the acoustic array, wherein the second delay is included in the first set of delay times, and
adding the first portion of the acoustic energy to the second portion of the acoustic energy and to a third portion of the acoustic energy;
comparing the first sum of the acoustic energy, a second sum of the acoustic energy associated with a second set of delay times, and a third sum of acoustic energy that is associated with a third set of delay times; and
identifying a location of the first type of sound source based on the first sum of acoustic energy being greater than the second sum of acoustic energy and the third sum of acoustic energy and based on the first set of delay times.

7. The method of claim 5, further comprising:
identifying a first magnitude of a first portion of sound energy received by a first sensor of a sensor array;
identifying a second magnitude of a second portion of the sound energy received by a second sensor of the sensor array;
identifying a third magnitude of a third portion of the sound energy received from a third sensor of the sensor array; and
identifying the estimated location of the type of sound source based on an evaluation that compares the first magnitude of the first portion of sound energy with the second magnitude of the second portion of sound energy and with the third magnitude of the third portion of the sound energy.

8. The method of claim 1, further comprising:
classifying the second subset of the plurality of characteristics as belonging to a wellbore defect, wherein the actional assessment includes providing an alert to administrative staff that identifies the wellbore defect.

9. The method of claim 1, further comprising:
calculating a first power spectral density associated with a sound emitted by the first type of sound source by identifying power levels associated with a plurality of frequencies included in the sound emitted by the first type of sound source; and
calculating a second power spectral density associated with a sound emitted by the second type of sound source by identifying power levels associated with a plurality of frequencies included in the sound emitted by the first type of sound source.

10. The method of claim 1, further comprising:
estimating a first value of entropy by calculating a first set of sums that are associated with a first sound source, wherein the first sound source is the first type of sound source;
estimating a second value of entropy by calculating a second set of sums that are associated with a second sound source, wherein the second sound source is the second type of sound source;
adding the first value of entropy and the second value of entropy to generate a sum of entropies;
comparing the sum of entropies to a plurality of other entropy sums; and
identifying that the sum of entropies has a value that is lower than the other entropy sums.

11. The method of claim 10, further comprising:
identifying the first sound source and the second sound source based on the sum of entropies having the value that is lower than the other entropy sums.

12. A non-transitory computer-readable storage medium having embodied thereon instructions executable by one or more processors to implement a method comprising:
performing an evaluation to identify a plurality of characteristics of a set of sensed acoustic data;
comparing the plurality of characteristics of the sensed acoustic data with one or more characteristics of a first type of sound source;
identifying, based on the comparison, that a first subset of the plurality of characteristics corresponds to the one or more characteristics of the first type of sound source;
initiating a filtering function to separate the first subset of the plurality of characteristics from the set of acoustic data; and
performing an analysis on a second subset of the plurality of characteristics to identify metrics to associate with the second subset of the plurality of characteristics, wherein the second subset of the plurality of characteristics is associated with one or more characteristics of a second type of sound source and an actionable assessment is initiated based on the metrics identified by the analysis on the second subset of the plurality of characteristics being associated with the one or more characteristics of the second type of sound source.

13. The non-transitory computer-readable storage medium of claim 12, wherein the one or more processors execute the instructions to:
identify spectral content of the set of sensed acoustic data;
access stored data that includes the one or more characteristics of the first type of sound source; and
identify spectral content associated with the first type of sound source after accessing the stored data, wherein the filtering function separates the spectral content associated with the first type of sound source from the spectral content of the set of sensed acoustic data.

14. The non-transitory computer-readable storage medium of claim 12, wherein the first subset of the plurality of characteristics includes a set of frequencies of the first type of sound source.

15. The non-transitory computer-readable storage medium of claim 14, wherein the first subset of the plurality of characteristics of the type of sound source includes a magnitude of the set of frequencies of the sound source.

16. The non-transitory computer-readable storage medium of claim 12, wherein the one or more processors execute the instructions to:
identify an estimated location to associate with the second type of sound source based on an analysis of the one or more characteristics of the second type of sound source.

17. The non-transitory computer-readable storage medium of claim 12, wherein the one or more processors execute the instructions to:
identify a first sum of acoustic energy that is associated with a first set of delay times by:
delaying a first portion of the acoustic energy by a first delay based on the first portion of the acoustic energy being received by a first acoustic sensor of an acoustic array, wherein the first delay is included in the first set of delay times,
delaying a second portion of the acoustic energy by a second delay based on the second portion of the acoustic energy being received by a second acoustic sensor of the acoustic array, wherein the second delay is included in the first set of delay times, and
adding the first portion of the acoustic energy to the second portion of the acoustic energy and to a third portion of the acoustic energy;
comparing the first sum of the acoustic energy, a second sum of the acoustic energy associated with a second set of delay times, and a third sum of acoustic energy that is associated with a third set of delay times; and
identify a location of the first type of sound source based on the first sum of acoustic energy being greater than the second sum of acoustic energy and the third sum of acoustic energy and based on the first set of delay times.

18. The non-transitory computer-readable storage medium of claim 16, wherein the one or more processors execute the instructions to:
identify a first magnitude of a first portion of sound energy received by a first sensor of a sensor array;
identify a second magnitude of a second portion of the sound energy received by a second sensor of the sensor array;
identify a third magnitude of a third portion of the sound energy received from a third sensor of the sensor array; and
identify the estimated location of the type of sound source based on an evaluation that compares the first magnitude of the first portion of sound energy with the second magnitude of the second portion of sound energy and with the third magnitude of the third portion of the sound energy.

19. The non-transitory computer-readable storage medium of claim 12, wherein the one or more processors execute the instructions to:
classify the second subset of the plurality of characteristics as belonging to a wellbore defect, wherein the actional assessment includes providing an alert to administrative staff that identifies the wellbore defect.

20. An apparatus comprising:
a set of sensors that sense a plurality of characteristics of a set of sensed acoustic data;
a memory; and
one or more processors that execute instructions out of the memory to:
perform an evaluation to identify the plurality of characteristics of the set of sensed acoustic data;
compare the plurality of characteristics of the sensed acoustic data with one or more characteristics of a first type of sound source;
identify, based on the comparison, that a first subset of the plurality of characteristics corresponds to the one or more characteristics of the first type of sound source;
initiate a filtering function to separate the first subset of the plurality of characteristics from the set of acoustic data; and
perform an analysis on a second subset of the plurality of characteristics to identify metrics to associate with the second subset of the plurality of characteristics, wherein the second subset of the plurality of characteristics is associated with one or more characteristics of a second type of sound source and an actionable assessment is initiated based on the metrics identified by the analysis on the second subset of the plurality of characteristics being associated with the one or more characteristics of the second type of sound source.
